(19) United States
(12) Patent Application Publication
(10) Pub. No.: US 2001/0032373 A1
(43) Pub. Date: Oct. 25, 2001

(54) Pencil having extended eraser life

(76) Inventor: Angelo Davis, Marseilles, IL (US)

Correspondence Address: FITCH EVEN TABIN AND FLANNERY, 120 SOUTH LA SALLE STREET, SUITE 1600, CHICAGO, IL, 606033406

(21) Appl. No.: 09/782,567

(22) Filed: Feb. 13, 2001

Related U.S. Application Data
(60) Provisional application No. 60/194,867, filed on Apr. 6, 2000.

(51) Int. Cl. B43K 29/02

(52) U.S. Cl. 15/427; 15/431

(57) ABSTRACT

A writing device may include a writing portion, an eraser portion and an eraser holder that is movable along the axis of the writing portion, thereby allowing a user to move the eraser holder toward away from the eraser portion to expose additional eraser material.

The present application claims the benefit of U.S. Provisional application No. 60/194,867 filed Apr. 6, 2000.

### Background of the Invention

1. Field of the Invention

The present invention is directed to writing instruments and, more particularly, to a pencil having an extended eraser life.

2. Description of the Prior Art

Conventional pencils fabricated from wood any other suitable material and having an axial lead portion disposed therein are known. Such a conventional pencil is sharpened to reveal the axial lead portion, which is used for writing. It is also well known that a conventional pencil commonly has an eraser fixed to one end thereof by a metal ferrule or band that is fixedly crimped around both the pencil and the eraser. In such an arrangement, over half of the eraser may be enclosed within the ferrule and is wasted because it cannot be used for the purposes of erasing.

Conventional pencils are commonly distributed, collected and reused in situations such as standardized testing, course evaluations, voting and other suitable applications. Such situations may involve rather minimal writing activities (e.g., completing the dots of standardized test answer sheet), but may involve substantial erasing activities. Accordingly, in such situations, the available eraser portion of the pencil may be worn out long before the writing portion of the pencil is rendered useless from writing and sharpening. When an eraser portion of a pencil is worn out, that pencil is commonly discarded, despite the fact that the portion of the eraser behind the ferrule could extend the useful life of the entire pencil. Accordingly, substantially full length pencils having ample writing portions and no available eraser material are commonly wasted.

A prior approach toward enabling the use of that portion of eraser material conventionally held behind a ferrule is disclosed in U.S. Pat. No. 5,526,548 to Ostrowski, which discloses a scored ferrule that allows a user to remove portions thereof. Ostrowski has at least two shortcomings. First, as portions of the ferrule are removed, such portions will likely be discarded as litter, or worse yet, may be thrown at other test takers or students. Such situations are at best messy and at worst dangerous. Second, because the ferrule of Ostrowski is scored, it is weak and, therefore, erasing that may put torque on the eraser can cause the ferrule to break, thereby leaving the eraser unsupported.

### SUMMARY OF THE INVENTION

According to a first aspect, the present invention may be embodied in a writing device that may include a writing portion having a length, a circumference and first and second ends and an eraser having a circumference substantially equivalent to the circumference of the pencil portion, the eraser abutting the first end of the pencil portion. The writing device may further include an eraser holder having an inner surface. The eraser holder is fit over and substantially encloses the circumferences of the pencil portion and the eraser. The eraser holder is adapted to be moved between first and second locations along the length of the pencil portion so that when the eraser holder is moved from the first location to the second location a portion of the eraser that was covered by the eraser holder when the eraser holder was in the first location is exposed when the eraser holder is moved to the second location.

According to some aspects, the writing portion may include an interior lead portion and an exterior supporting portion where the lead portion is fixed with respect to the supporting portion. In such an arrangement, the exterior supporting portion may be a wooden material or a synthetic material.

According to another aspect, the writing device may also include a plurality of raised substantially helical threads disposed on the inner surface of the eraser holder that enable the eraser holder to be threaded onto and moved between the first and second locations along the length of the writing potion.

In such an arrangement, the eraser holder may be fabricated from a metallic material or from a synthetic material.

In another aspect, the writing device may include an axial slot in the eraser holder and an upset portion disposed on the writing portion and inserted into the slot in the eraser holder to allow the eraser holder to move between the first and second locations along the length of the writing portion. Additionally, the writing device may include circumferential slots adjacent the axial slot in the eraser holder, wherein the circumferential slots are adapted to receive the upset portion. The eraser holder may be fabricated from a metallic material or from a synthetic material.

According to a second aspect, the present invention may be embodied in a writing device that includes a writing portion having a length, a circumference, a first end and a second end and an eraser having a circumference substantially equivalent to the circumference of the pencil portion, the eraser abutting the first end of the pencil portion. The writing device may also include a sleeve having an inner surface including a raised substantially helical thread. The eraser holder is fit over and substantially encloses the circumferences of the writing portion and the eraser. The sleeve is adapted to be threaded onto the writing portion to move between first and second locations along the length of the writing portion when the sleeve is rotated with respect to the writing portion so that when the sleeve is moved from the first location to the second location a portion of the eraser that was covered by the sleeve when the sleeve was in the first location is exposed when the sleeve is moved to the second location.

According to a third aspect, the present invention may be embodied in a writing device that may include a writing portion having a length, a circumference, first and second ends and an upset potion and an eraser having a circumference substantially equivalent to the circumference of the pencil portion, the eraser abutting the first end of the pencil portion. The writing device may also include a sleeve having an inner surface comprising an axial slot adapted to accommodate the upset portion on the writing portion to allow the sleeve to move between first and second locations along the length of the writing portion so that when the sleeve is moved from the first location to the second location a portion of the eraser that was covered by the sleeve when the sleeve was in the first location is exposed when the sleeve is moved to the second location.

These and other aspects of the present invention will be readily appreciated upon review of the detailed description of the embodiments, which are described in conjunction with the figures, a brief description of which follow.

### BRIEF DESCRIPTION OF THE DRAWINGS

FIG. 1 illustrates a pencil having a movable ferrule;

FIG. 2 is a detailed view of one embodiment of a movable ferrule installed on a pencil;

FIG. 3 is a detailed view of a portion of material from which the movable ferrule of FIG. 2 is fabricated;

FIG. 4 is a cross sectional view taken generally along lines 4-4 of FIG. 2;

FIG. 5 is a detailed view of a second embodiment of a removable ferrule installed on a pencil; and

FIG. 6 is a detailed view of a portion of material from which the removable ferrule of FIG. 5 is fabricated.

### DESCRIPTION OF THE EMBODIMENTS

As disclosed herein, a pencil may include a movable ferrule, sleeve or eraser holder, that allows previously unavailable eraser portions to be used. As the available portion of usable eraser is depleted due to erasing, a user may move the movable ferrule from an original position to one or more positions that are located closer to the writing tip of the pencil, thereby exposing additional eraser material that may be utilized by the user. The embodiments disclosed hereinafter fully support an eraser and do not contribute waste materials that must be removed from the ferrule to access any additional portions of an eraser. While two particular embodiments are disclosed hereinafter, those having ordinary skill in the art will readily recognize that such embodiments are merely exemplary and are not intended to be limiting in any way. In the following description that is provided with respect to the figures, like reference numeral refer to like elements.

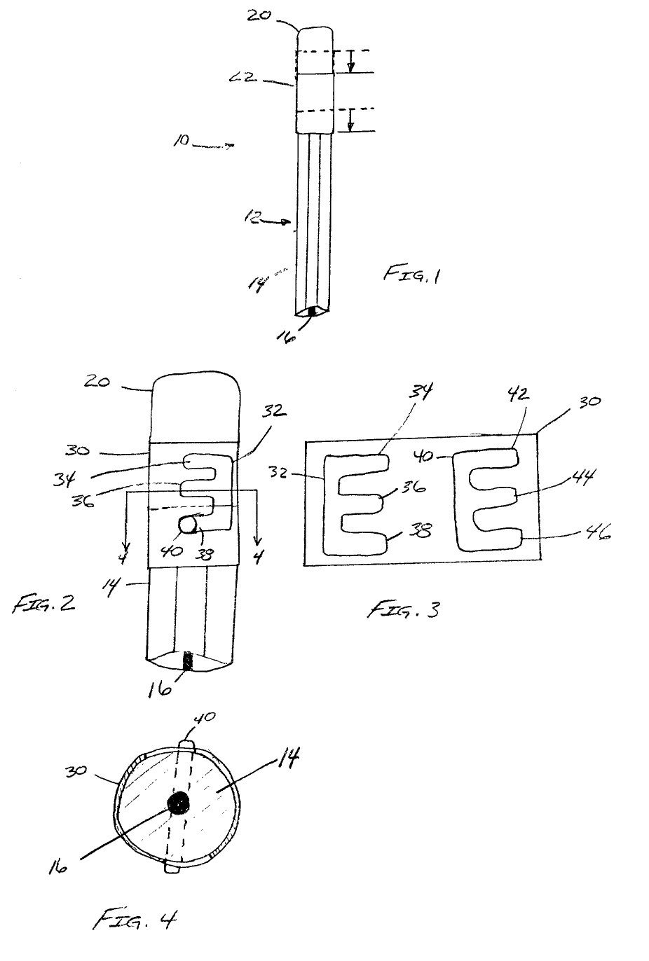

Turning now to FIG. 1, a pencil 10 generally includes a writing portion 12, including a supporting portion such as a wooden or synthetic case 14 and a lead portion 16 disposed within the case 14, an eraser 20 and an eraser holder such as a ferrule 22. The ferrule 22, which is movable between a number of positions, may be fabricated from steel or from any other suitable metallic or synthetic material such as plastic, or the like.

As a user wears the eraser 20 away, the ferrule 22 may be moved away from the eraser 20 and toward the tip of the writing portion 12. For example, as shown in FIG. 1, the ferrule 22 may be moved from the position represented by the dashed lines and may be moved to the position in which the ferrule 22 is shown in FIG. 1. The ability to move the ferrule 22 axially along the length of the pencil 10 allows portions of the eraser 20, which were previously increaseable because of a fixed ferrule, to be used for erasing as the ferrule 22 is moved toward the tip of the writing portion. In such an arrangement, the ferrule 22 may be moved toward the writing portion 12 in a manner that fully supports the eraser 20.

A first embodiment, as shown in FIG. 2, not only includes the case 14, the lead portion 16 and the eraser 20, but also includes a movable ferrule 30.

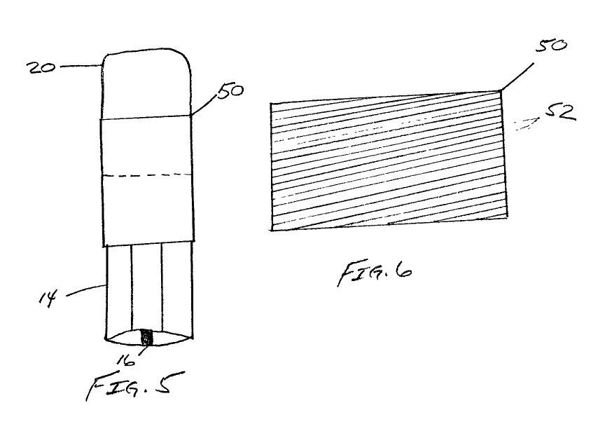

As shown in FIGS. 2 and 3, the ferrule 30 includes a removed portion 32 including a number of fingers 34-38 that form circumferential slots when the ferrule 30 is formed into a substantially cylindrical shape around the writing portion 12 and the eraser 20. An upset portion, such as a stud 40, rides within the removed portion 32 to control the movement of the ferrule 30. The user may move the ferrule 30 rotationally and axially with respect to the stud 40, which as shown in FIG. 4, is mounted through the case 14 and lead portion 16 of the writing portion 12. As further shown in FIG. 3, the ferrule 30 may include a second removed portion 40 also including a number of fingers 42-46. As with the removed portion 32 and the fingers 34-38, the second removed portion 40 and fingers 42-46 also accommodate the stud 40 when the ferrule 30 is formed into a substantially cylindrical shape around the writing portion 12 and the eraser 20.

When a user first begins using the pencil 10 as shown in FIG. 2, the stud 40 may be engaged in the finger 38. However, as the eraser 20 is worn down, the user may rotate the ferrule 30 until the stud 40 is located in the axial slot of the ferrule 30 and may then move the ferrule 30 until the stud 40 aligns with the finger 36. The user may then rotate the ferrule 30 to engage the stud 40 within the finger 36. Likewise, the stud 40 may be engaged in the finger 34. Of course, as the ferrule 30 is rotated and moved axially, the stud 40 is also accommodate by the second removed portion 40 and fingers 42-46. For example, when the stud 40 is engaged in fingers 34, 36 or 38, the stud 40 will also be engaged in fingers 42, 44 or 46, respectively.

Turning now to FIGS. 5 and 6, a second embodiment of a ferrule 50 is shown. According to the second embodiment, the ferrule 50 includes a plurality of raised portions, or threads 52, disposed thereon. As shown in FIG. 6, the threads 52 may be angled with respect to the ferrule 50 so that when the ferrule 50 is installed around the eraser 20 and the case 14, the threads 50 form a helical geometry that enables the ferrule 50 to move along the axis of the writing portion 12 as the ferrule 50 is rotated with respect to the writing portion 12. As the ferrule 50 is rotated with respect to the writing portion, the threads 50 engage the outer periphery of the case 14 and pull the ferrule 50 along the axis of the writing portion 12 and toward the writing tip thereof, thereby exposing a portion of eraser 20 that was previously hidden behind the ferrule 50. Accordingly, as the eraser 20 is worn down by use, a user may twist the ferrule 50 toward the writing tip to expose additional eraser 20.

Both of the embodiments shown in the drawings enable a ferrule to move axially with respect to the writing portion and the eraser portion. the axial movement of the ferrule allows a user to reveal unused portions of eraser, thereby prolonging the useful life of the pencil having the movable ferrule.

What is claimed is:

1. A writing device, comprising:
a writing portion having a length, a circumference and first and second ends;
an eraser having a circumference substantially equivalent to the circumference of the pencil portion, the eraser abutting the first end of the pencil portion; and
an eraser holder having an inner surface, wherein the eraser holder is fit over and substantially encloses the circumferences of the portion and the eraser and wherein the eraser holder is adapted to be moved between first and second locations along the length of the portion so that when the eraser holder is moved from the first location to the second location a portion of the eraser that was covered by the eraser holder when the eraser holder was in the first location is exposed when the eraser holder is moved to the second location.

2. The writing device of claim 1, wherein the writing portion comprises an interior lead portion and an exterior supporting portion and wherein the lead portion is fixed with respect to the supporting portion.

3. The writing device of claim 2, wherein the supporting portion comprises a wooden material.

4. The writing device of claim 2, wherein the supporting portion comprises a synthetic material.

5. The writing device of claim 1, further comprising a plurality of raised substantially helical threads disposed on the inner surface of the eraser holder that enable the eraser holder to be threaded onto and moved between the first and second locations along the length of the writing potion.

6. The writing device of claim 5, wherein the eraser holder comprises a metallic material.

7. The writing device of claim 5, wherein the eraser holder comprises a synthetic material.

8. The writing device of claim 1, further comprising an axial slot in the eraser holder and an upset portion disposed on the writing portion and inserted into the slot in the eraser holder to allow the eraser holder to move between the first and second locations along the length of the writing portion.

9. The writing device of claim 8, further comprising circumferential slots adjacent the axial slot in the eraser holder, wherein the circumferential slots are adapted to receive the upset portion.

10. The writing device of claim 9, wherein the eraser holder comprises a metallic material.

11. The writing device of claim 9, wherein the eraser holder comprises a synthetic material.

12. A writing device, comprising:
a writing portion having a length, a circumference, a first end and a second end;
an eraser having a circumference substantially equivalent to the circumference of the pencil portion, the eraser abutting the first end of the pencil portion; and
a sleeve having an inner surface including a raised substantially helical thread, wherein the eraser holder is fit over and substantially encloses the circumferences of the writing portion and the eraser and wherein the sleeve is adapted to be threaded onto the writing portion to move between first and second locations along the length of the writing portion when the sleeve is rotated with respect to the writing portion so that when the sleeve is moved from the first location to the second location a portion of the eraser that was covered by the sleeve when the sleeve was in the first location is exposed when the sleeve is moved to the second location.

13. The writing device of claim 12, wherein the cylindrical writing portion comprises an interior lead portion and an exterior supporting portion, wherein the lead portion is fixed with respect to the supporting portion.

14. The writing device of claim 13, wherein the supporting portion comprises a wooden material.

15. The writing device of claim 12, further including a plurality of raised substantially helical threads disposed on the inner surface of the sleeve.

16. The writing device of claim 12, wherein a center of an axial length of the sleeve is substantially aligned with the abutment of the eraser and the writing portion when the sleeve is in the first location.

17. The writing device of claim 12, wherein the sleeve comprises a metallic material.

18. The writing device of claim 12, wherein the sleeve comprises a synthetic material.

19. The writing device of claim 12, wherein the sleeve comprises a substantially cylindrical shape.

20. A writing device, comprising:
a writing portion having a length, a circumference, first and second ends and an upset potion;
an eraser having a circumference substantially equivalent to the circumference of the pencil portion, the eraser abutting the first end of the pencil portion; and
a sleeve having an inner surface comprising an axial slot adapted to accommodate the upset portion on the writing portion to allow the sleeve to move between first and second locations along the length of the writing portion so that when the sleeve is moved from the first location to the second location a portion of the eraser that was covered by the sleeve when the sleeve was in the first location is exposed when the sleeve is moved to the second location.
